(19) United States
(12) Patent Application Publication
(10) Pub. No.: US 2023/0110991 A1
(43) Pub. Date: Apr. 13, 2023

(54) RELEASING AN ALTERNATIVE PATH IN CELLULAR COMMUNICATIONS

(71) Applicant: IPCOM GMBH & CO. KG, Pullach (DE)

(72) Inventors: Maik BIENAS, Schoeppenstedt (DE); Martin HANS, Bad Salzdetfurth (DE)

(73) Assignee: IPCOM GMBH & CO. KG, Pullach (DE)

(21) Appl. No.: 17/906,076

(22) PCT Filed: Mar. 16, 2021
(86) PCT No.: PCT/EP2021/056669

§ 371 Date: Sep. 12, 2022

(30) Foreign Application Priority Data
Mar. 24, 2020 (EP) 20165221.1

(51) Int. Cl. H04W 76/15; H04W 76/25; H04W 76/30; H04W 60/06

(52) U.S. Cl. CPC H04W 76/15; H04W 76/25; H04W 76/30; H04W 60/06; H04W 84/042

(57) ABSTRACT

The present invention provides a mechanism for controlling a connection to a second PLMN via a first PLMN when a connection between user equipment and the first PLMN is no longer carrying user data. Either the first PLMN or the user equipment may determine whether the connection to the second PLMN should be released.

A number of cellular telephones are adapted to enable the use of multiple mobile phone contracts simultaneously, e.g. one for business and one for personal use. Such mobile devices support the feature “dual SIM” (SIM=Subscriber Identity Module). This enables the device to be registered with two subscriptions at the same or two different PLMNs (public land mobile network) simultaneously using two different UMTS SIMs (USIMs) implemented on two different UICCs (Universal Integrated Circuit Cards). Two implementations are generally possible, so-called “dual SIM dual active” (DSDA) phones where two connections can be active at the same time and so-called “dual SIM dual standby” (DSDS) phones. In the latter, support is provided for both SIMs to operate in idle mode. This means that in case a connection is established towards the radio access network (RAN) of a first PLMN (using the USIM), it is not possible for the mobile device (UE) to transmit any signals to the RAN of the second PLMN (UE type=dual RX/single TX) and for some device types it would additionally not be possible to receive any signals from the RAN of the second PLMN (UE type=single Rx/single Tx). Therefore, such devices may suffer from reduced availability.

Dual SIM devices have been known for about ten years, but up to now there was no standardized way of optimizing the parallel usage of two or more USIMs. Standardized solutions for this issue are currently under discussion in 3GPP within a study titled “MUSIM” which is described in 3GPP Tdoc S2-2001827. The focus of this study is on solutions to limit the effect of reduced availability, e.g. how to avoid unnecessary interruptions and whether it is useful to inform the network about planned interruptions.

Beside this new study, it is already specified how to use external access systems, that are not part of a PLMN and whose access technology is not specified by 3GPP. The access type is then called “non-3GPP access”, in the usual case in which there is no trust relationship between a PLMN and the non-3GPP access, the access is also called “untrusted non-3GPP access”. Typical examples for such non-3GPP access technologies are Wi-Fi (WLAN) or fixed broadband access.

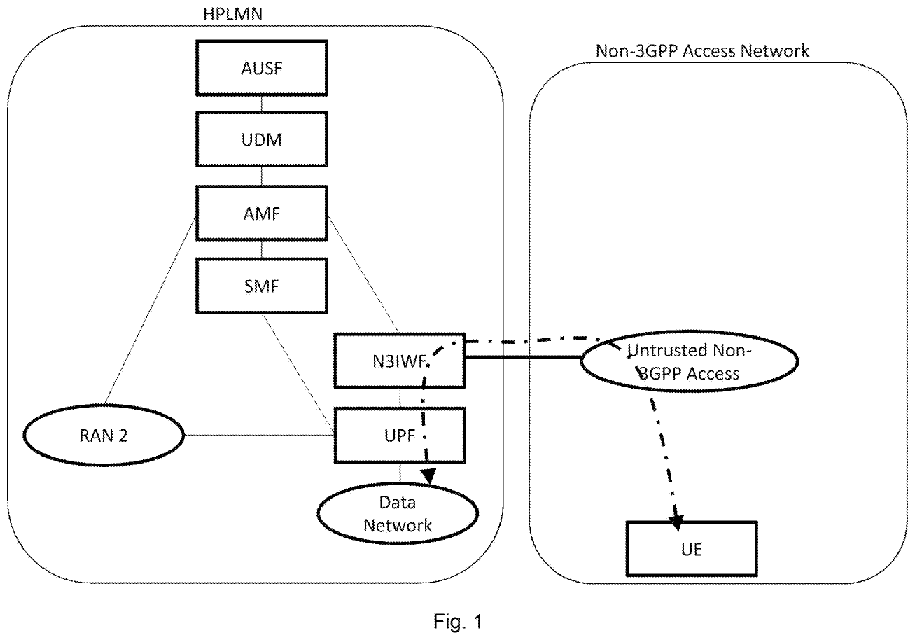

A 5G architecture for non-3GPP access is depicted in FIG. 1. The untrusted non-3GPP access network is connected via a non-3GPP interworking function (N3IWF) with the home PLMN (HPLMN). A path of the user data between the UE and a data network of the PLMN is depicted in FIG. 1 as a “dash-dot” line with arrows. The UE is controlled by an access and mobility function (AMF) in the PLMN while the non-3GPP access network is not controlled by the PLMN. More details on this architecture can be found in 3GPP TS 23.501 at 4.2.8.

For dual SIM devices that have a single transmitter and potentially also a single receiver, the following challenges in general exist: The devices can be in idle mode in two different radio access networks (RANs), camp on a selected cell in each of the RANs and listen to paging in the configured paging occasions. An overlap in paging occasions may lead to missed reception of paging messages, which is an acceptable and minor issue as paging occasions occur repeatedly. In case an event for setting up a connection to one of the PLMNs occurs, the transceiver of the UE device will be used for setting up a link to the respective RAN. The transceiver will thus not be available to receive paging messages from the second PLMN via the second RAN and it would also not be available for setting up a link in case a respective event occurs in the device or in the second PLMN. An event for setting up a connection may for example be a mobile terminated voice or video call, a mobile originated call, reception or transmission of an SMS, packet data transfer or core network signaling, e.g. a reregistration to update the UE device's location or tracking area.

The currently discussed MUSIM study has the aim to provide a reduction of the connection interruptions to a PLMN caused by hardware limitations of a multi-USIM device. Some of the solutions currently discussed, e.g. in 3GPP Tdoc S2-2000302, use a connection to a first PLMN to connect to the N3IWF of a second PLMN to register in the second PLMN, receive respective paging notification messages and potentially establish a data connection to the second PLMN. These solutions ensure availability of the mobile device from the second PLMN although the device's transceiver is solely connected to the RAN of the first PLMN. With regards to the connection to the second PLMN, the first PLMN offers an alternative path. The related architecture on which this invention is built is described in 3GPP TS 23.501 at 5.30.2.7 and 5.30.2.8. 3GPP document S2-2001424 is a revised version of Tdoc S2-2000302. In this document, it is assumed that the UE is notified via PLMN1 about new downlink data that has arrived in PLMN2 while in PLMN1 no active data connections exist. To receive the data, the UE may decide to connect directly with PLMN2 or to stay in PLMN1. This document does not disclose a method to release the second connection in case no user data needs to be transmitted in any involved PLMN. A further MUSIM document is 3GPP document S2-2000732 in which an incoming IMS voice call for USIM2 is assumed. MUSIM operation is also the subject of 3GPP document S2-2000650.

For these solutions, a PDU session is set up within the connection to the first PLMN to a data network of the first PLMN that enables a connection to the interworking function (N3IWF) of the second PLMN. If the UE device is in idle mode in the second PLMN, the connection to the first PLMN via the described alternative path is first used to register the UE device via the interworking function (N3IWF) in the second PLMN and inform the second PLMN about the reachability of the UE device via the alternative path. After that, the alternative path is used by the second PLMN to transmit notification messages to the UE device and thereby request the UE device to set up a data connection or receive an SMS, i.e. to notify the UE device similarly as with paging messages in a RAN. If the UE device changes from idle to connected mode in the second PLMN, e.g. because one or more connection events occur in the second PLMN, the alternative path is used to transfer data according to the respective connection event or events, e.g. voice or video call or data services.

As indicated above, the entity that enables access from a UE to a PLMN over untrusted non-3GPP access technologies is the N3IWF. In case of the use of the same or a similar entity to access the PLMN via another PLMN, the access is not “non-3GPP”, therefore the entity today known as N3IWF may need to have its functionality enhanced and possibly be renamed towards a general interworking function. Throughout this document the terms interworking function, non-3GPP interworking function and N3IWF are exchangeable and are not meant to be limited in meaning to these terms as used in current arrangements.

For the above-mentioned solutions using an alternative path via an interworking function (N3IWF), a mobile device (user equipment, UE) connected to a first PLMN via a RAN of the first PLMN establishes a connection, here called PDU session, to a data network of the first PLMN that enables the UE device to connect to the N3IWF of the second PLMN. This may for example be a general data network like the internet and the connection to the N3IWF of the second PLMN is routed through the public internet. In any case, the first PLMN is not aware that the PDU session is established for the purpose of connecting to the second PLMN. All data exchanged between the second PLMN and the UE device is just unspecified user data for the first PLMN.

The first PLMN is not aware that the establishment of this PDU session is a result of that the transceiver of the UE device being used for the connection of the UE device to the first PLMN, i.e. the reason of having the PDU session established is the event or events that caused the connection of the UE device to the first PLMN.

In case of an ending of all events that cause a connection between the UE device and the first PLMN, the connection will not be terminated due to the PDU session established for the connection of the UE device to the N3IWF of the second PLMN. The first PLMN will thus not terminate the connection, it will keep the UE device connected to the RAN of the first PLMN and thus the UE device will not fall back to idle mode in which it can use its transmitter to listen to paging of both its PLMNs. The present invention addresses this deficiency.

The present invention provides a method for controlling a connection of a user equipment, UE, device having more than one subscriber identity module, SIM, to at least a first and a second public land mobile network, PLMN, in which initially the UE device is connected to the first PLMN via a radio access network, RAN, of the first PLMN forming a first connection associated with a first SIM and the UE device is connected to the second PLMN via a data network of the first PLMN and an interworking function of the second PLMN forming a second connection associated with a second SIM, the method comprising determining that the first connection is being maintained only for maintenance of the second connection; and then causing the second connection to be released and a new connection associated with the second SIM to be established with the second PLMN via an access network of the second PLMN.

The present invention thus provides means for termination or release of an active connection between a UE device and a first PLMN despite an ongoing PDU session that is used for a connection to a second PLMN.

Once the above means are established, the connection between the first PLMN and the UE device is terminated based on the determination that all PDU sessions but the one(s) used for connecting to the N3IWF of the second PLMN are terminated or are due to be terminated. The UE device will go to idle mode in both PLMNs. The termination of the UE device's connection to the second PLMN's N3IWF and the re-established ability of the UE device to connect to the RAN of the second PLMN will cause the UE device to re-register itself to the second PLMN via that PLMN's RAN, e.g. in order to update the location or tracking area of the UE device and register the new path via the RAN in the second PLMN.

In this case, the UE device should be prevented from establishing a PDU session via the second PLMN to connect to the N3IWF of the first PLMN because otherwise this would lead to a ping pong effect: The UE device would swing from the first to the second PLMN and vice versa for re-registering itself alternating via N3IWF and RAN. The present invention thus also provides in one aspect a mechanism for making a decision in the UE device as to whether a PDU session needs to be set up via a first PLMN to connect to a second PLMN via the second PLMN's N3IWF.

It is assumed that a connection towards a second PLMN is not possible via the radio access network (RAN) provided by this second PLMN due to an ongoing connection towards a first PLMN by using the related RAN, because the UE is not able to transmit any signals to more than one RAN at the same time.

It is further assumed that the following situation exists:
a UE device with multiple USIMs of different PLMNs and single transmit capabilities has a connection to a first PLMN via one or more first links to a RAN of the first PLMN;
the connection to the first PLMN causes an interruption of the UE device's ability to connect to a second PLMN;
the connection to the first PLMN is established for one or more connection events, the connection events being at least one of an exchange of control messages between the UE device and the first PLMN, and the setup of one or more PDU sessions for exchange of data between the UE device and a data network of the first PLMN to enable a service of the first PLMN other than connecting to another PLMN; and
the UE device has set up an alternative path to the second PLMN, the alternative path comprising one or more PDU sessions with a data network of the first PLMN for connecting via the data network of the first PLMN and an interworking function (N3IWF) of the second PLMN to the second PLMN.

In one aspect, the invention provides for:
a determination, that all connection events causing the connection to the first PLMN have or are due to be ended and that the connection to the first PLMN is to be released,
a determination, whether an ongoing connection from the UE to the second PLMN via the alternative path is suited to be handed over to the RAN of the second PLMN in order to release the alternative path,
a determination, whether an ongoing connection from the UE to the second PLMN via the alternative path is only for non-access stratum (NAS) signaling and therefore is suited to be released,
transmission of a connection release request to the second PLMN via the N3IWF, the request comprising a notification that a reregistration is intended (via the RAN of the second PLMN), this notification may be used to suspend the data exchange via the alternative path, it may further prepare the second PLMN to receive a reregistration via the RAN of the second PLMN, it may also trigger a handover of PDU sessions between the two accesses, it may further initiate an AMF selection process to provide the identification of an AMF to the UE device at which the UE device is to be registered via the RAN of the second PLMN,
a release of the connection to the first PLMN and consequently the release of the alternative path to the second PLMN (in either order),
a switch of the UE device to Idle mode and a cell selection in at least the RAN of the second PLMN, and
a registration of the UE device in the second PLMN via the RAN of the second PLMN.

The determination, that all connection events have ended, can be done in the UE device or in the first PLMN. The UE device may base the detection on established PDU sessions and their respective mapping to services or applications. If all PDU sessions that are established to transport user data of applications and application layer service of the first PLNM are terminated or inactive for a certain time, the UE device may determine that there is no reason to keep these PDU sessions. Some PDU sessions may also be determined to be of low priority and the determination may include to determine that all high and mid priority services are inactive or terminated and PDU sessions for low priority services are ignored.

The notification may be transmitted by the UE device in form of a NAS message to the AMF in the second PLMN.

In case the UE device is in idle mode in the second PLMN, the notification message may either terminate the registration, i.e. it triggers a deregistration, or it suspends the connection to ensure paging notifications are delayed until a new connection is established. The notification message may alternatively be omitted, i.e. the second PLMN will not be informed about a release of the connection until the UE device re-registers over another access.

In case the UE device is in connected mode in the second PLMN, the notification NAS message may be a message requesting handover from the current access, i.e. either over N3IWF, to an access via the RAN of the second PLMN. The request to handover may comprise a reason information informing the second PLMN about the possibility or necessity to release the access via the first PLMN.

The release of the alternative path can be triggered by the UE device or the first PLMN.

The UE device may request release of the connection to the RAN of the first PLMN (release of the RRC connection), i.e. it may request to be sent to idle mode.

Alternatively, the UE device may request from the first PLMN release of the PDU sessions used for connecting to the second PLMN and as a result the first PLMN may release the PDU sessions and send the UE device to Idle mode.

If the subsequent registration of the UE device in the second PLMN via the RAN of the second PLMN is the only purpose of establishing a connection of the UE device with the second PLMN, the UE is prevented from requesting the setup of a PDU session in the second PLMN for connecting to an Interworking Function (N3IWF) of the first PLMN. This prevention may be based on an estimation of how long the UE device will be in connected mode in the RAN of the second PLMN, e.g. only for re-registering and potentially some minor control signaling in addition, or for setting up user plane resources and exchange of data with a data network of the second PLMN.

A benefit of this invention is, that it will reduce usage of a non-home network to the required minimum and will allow to use the RAN idle mode to save energy in the UE and the network and to reduce waste of radio resources. Also, due to the optimized usage of the first PLMN's resources, the invention may increase the acceptance in a PLMN of the setup of PDU sessions for connections to different PLMNs which may otherwise be prevented by a PLMN.

In the present invention, where no user data needs to be transmitted via the second connection and in the first PLMN no active data connections exist beyond the connection for maintaining the connection to the second PLMN, this condition may be detected and the second connection will be released.

Preferred embodiments of the invention will now be described, by way of example only, with reference to the accompanying drawings in which:

FIG. 1 is a schematic representation of a prior art mechanism for providing non-3GPP access to a PLMN via an interworking function;

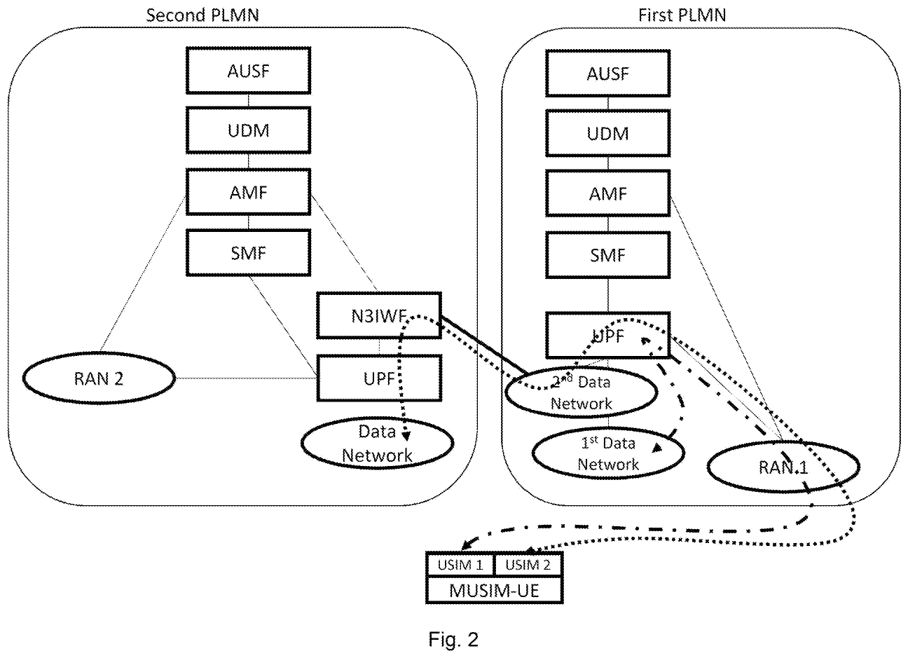

FIG. 2 is a schematic illustration of a connection to an interworking function of a second PLMN to a first PLMN in communication with a dual SIM UE device;

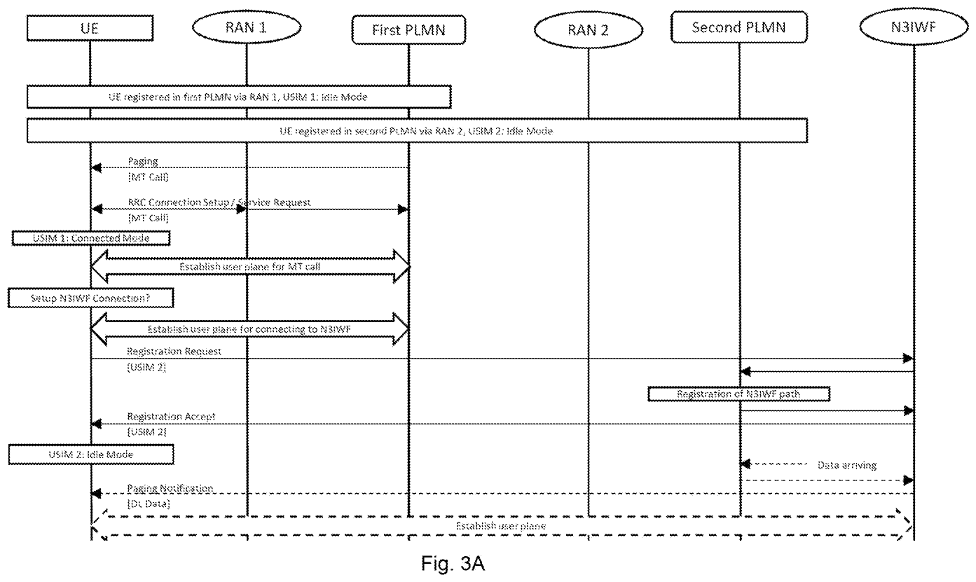

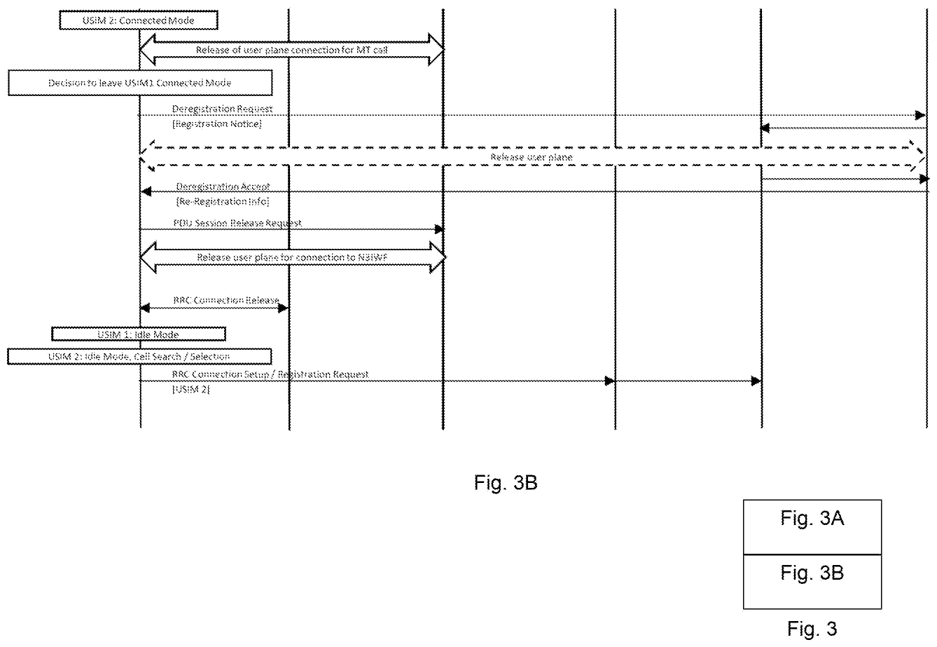

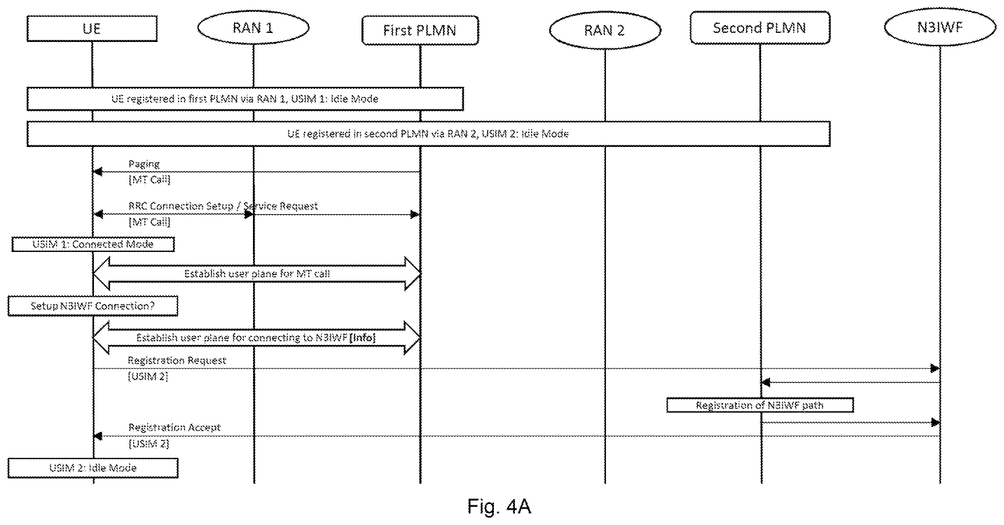

FIG. 3 is a message flow chart of a first aspect of the invention split between parts 3A and 3B as shown;

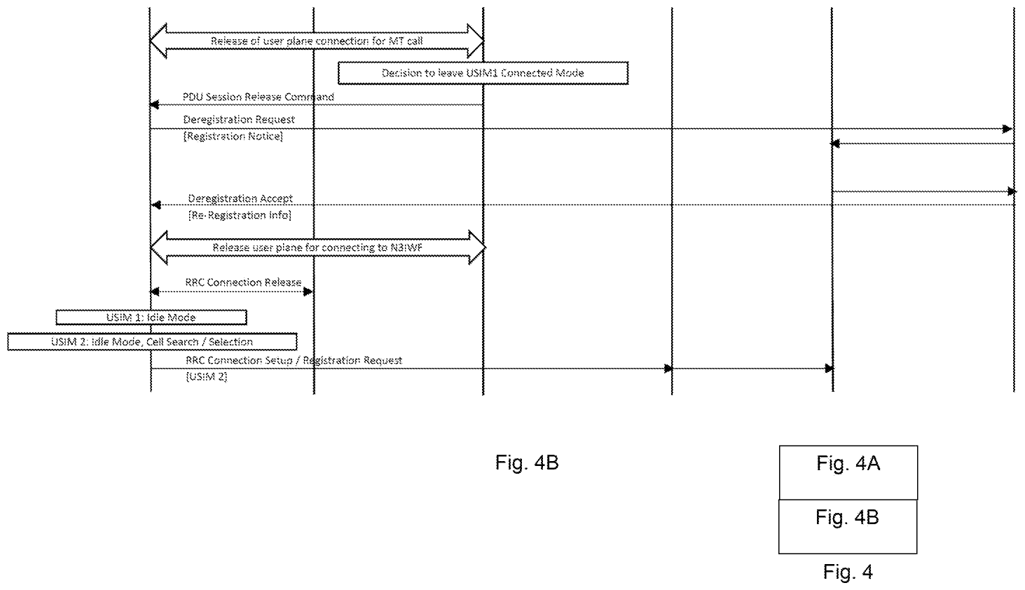

FIG. 4 is a message flow chart of a second aspect of the invention split between parts 4A and 4B as shown; and

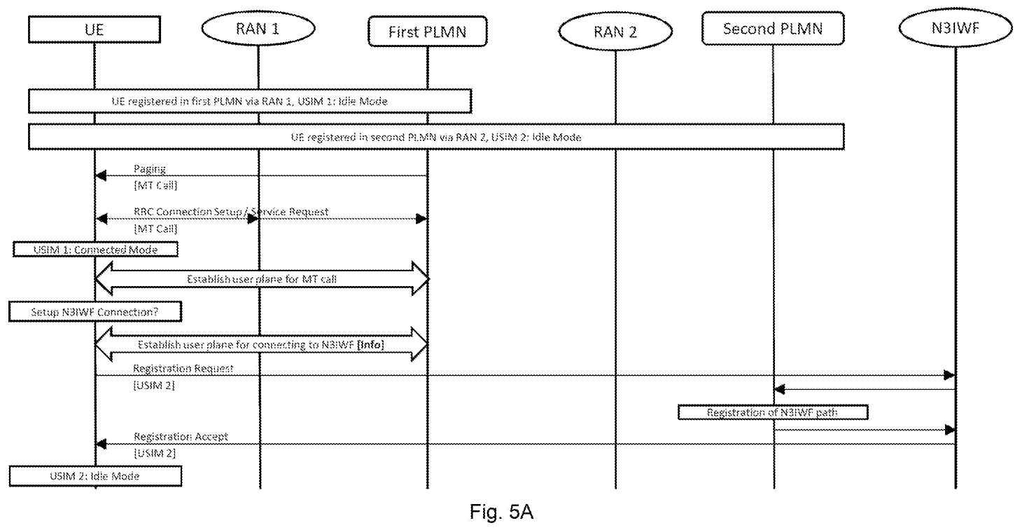

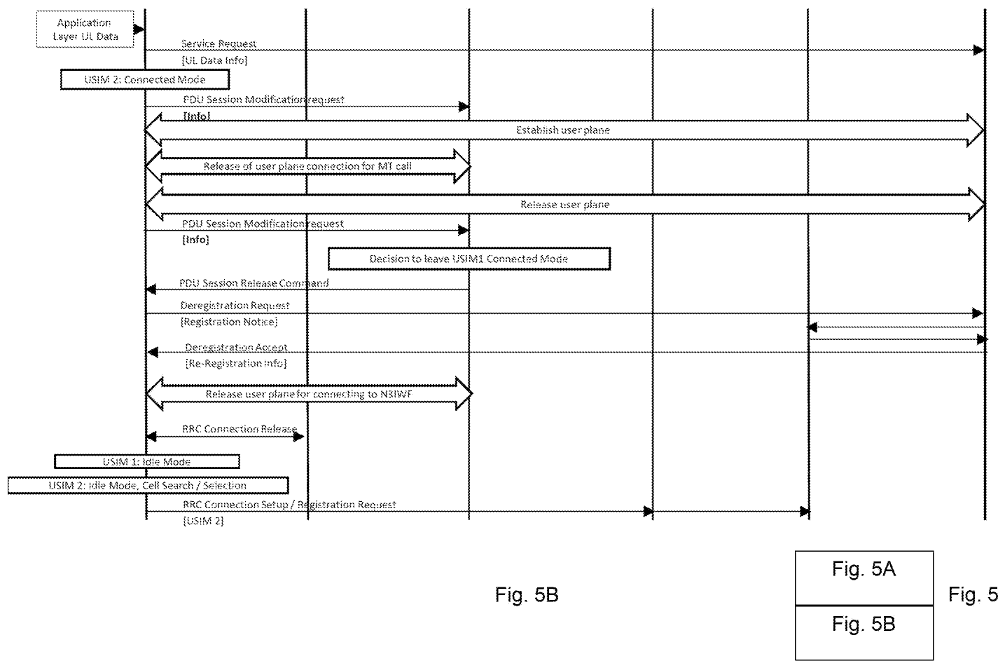

FIG. 5 is a message flow chart of a third aspect of the invention split between parts 5A and 5B as shown.

FIG. 2 shows a 5G communication network according to the present invention. Operating principles according to 5G are also be applicable to other communication standards including and not limited to UMTS, HSPA, LTE and potential future communication standards. A UE device has a multi SIM capability, i.e. it is capable of being simultaneously registered to multiple PLMNs (at least 2) and receiving signals in the downlink from the registered PLMNs such as paging messages or system information.

The UE device contains at least a USIM 1 related to the first PLMN and a USIM 2 related to the second PLMN. It is not capable of transmitting simultaneously signals to more than one RAN of a PLMN at a time. E.g. in case it is connected to a first PLMN via that PLMN's RAN, it is not able to transmit to a second PLMN via the RAN of the second PLMN.

FIG. 2 shows the UE device with its two USIMs (USIM 1 and USIM 2) and the two PLMNs (First PLMN and Second PLMN). The PLMNs are shown with their major functions for authenticating the UE device (AUSF, UDM and AMF) and managing it (AMF and SMF). Also, a user plane is shown, i.e. functions and entities that contribute to the actual data routing: The user plane function (UPF) routes data for a UE device to one or more data networks. Each PLMN is shown to have one radio access network (RAN 1 and RAN 2, respectively). The second PLMN has a non-3GPP interworking function (N3IWF) that allows access to the PLMN from untrusted networks, e.g. the internet.

Arrows show in FIG. 2 two data paths related to USIM 1 and USIM 2, respectively. The data path related to USIM 1 connects the UE device with RAN 1 and via the UPF to a first data network. This may for example be an IP-based multimedia subsystem (IMS) of the first PLMN offering voice and video calls to the UE device. The data path related to USIM 2 uses the same connection between the UE device and RAN 1 via a UPF to a second data network. The UPF may be different or the same as for the connection to the first data network and the first and second data networks may be identical or distinct. The second data network connects the UE device to a N3IWF of the second PLMN. The N3IWF routes the data via a UPF of the second PLMN to a data network of that PLMN which again may be an IMS for voice and video calls, the internet or any other data network of the second PLMN. In addition and not shown by grey arrows, RAN 1 connects the UE device to an AMF of the first PLMN for exchange of control data related to the subscription of USIM 1 and likewise the N3IWF of the second PLMN connects the UE device to an AMF of the second AMF for exchange of control data related to the subscription of USIM 2.

In a first embodiment, which is described in the following, the UE device triggers the release of the alternative path. As a prerequisite of this embodiment the following steps are assumed to take place to set up the connections indicated by the arrows of FIG. 2.

These steps are shown in the upper part of FIG. 3:

The UE device is registered with its USIM 1 and 2 in the first and second PLMN, respectively, and is in idle mode, i.e. no connection to a RAN is active. It is now assumed that the first PLMN receives an indication for a mobile terminated voice call (MT Call) for the UE device. The first PLMN requests the UE device to set up a connection by transmitting one or more paging messages including the paging cause (MT Call).

The UE device responds to the reception of the paging message by accessing RAN 1 and requesting the setup of an RRC connection and subsequent service request for setting up user plane resources, i.e. one or more related PDU sessions, for the voice call. Now, the UE device is in connected mode with respect to USIM 1 and the first PLMN.

The UE device is now not reachable by the second PLMN because of its connection to RAN 1 and its limited transmission and reception capabilities.

For this embodiment, FIG. 3 is described omitting any dashed lined objects which will be described in another embodiment.

To describe the current invention, the following steps follows the above example for establishment of the connection setup in the first PLMN.

After determining that the UE device is not reachable by the second PLMN, the device determines whether reachability in the second PLMN is of high enough importance and if so, establishes an alternative path by requesting at the first PLNM setup of one or more PDU sessions to a data network that allows a connection to the N3IWF of the second PLMN. The determination may take into account an estimation of the time the UE device will be in connected mode in the first PLMN based on the service the UE device receives, on current activities on the application layer of the UE device and estimations of future activities.

Over this or these PLMN sessions a registration in the second PLMN takes place with respect to USIM 2, the second PLMN registers the new path to the UE device. It is assumed in this embodiment that no data connection is required and thus the second PLMN send the UE device to idle mode, i.e. a secure connection to the N3IWF is maintained, but no user or control data is exchanged between the UE device and network. Paging may be received by the UE device from the second PLMN via paging notification messages.

It is now assumed that the MT call of the UE device in the first PLMN terminates and no additional data exchange is ongoing or foreseen in the first PLMN. The user plane connection for the MT call, i.e. all related PDU sessions, is released.

Now, the PDU session or sessions in the first PLMN used for a connection to the N3IWF of the second PLMN is the only reason to keep the UE device in an active connection to the first PLMN. This situation is determined by the UE device and a decision is taken to request from the first PLMN termination of this active connection and leave connected mode in the first PLMN.

It is thus an aspect of this invention to determine that despite an ongoing data connection (to the second PLMN), the active link to the first PLMN should be terminated and to request that termination at the first PLMN. The determination can include a determination whether more data is expected to be sent or received in the first PLMN and/or what kind of service was received in the first PLMN and whether this service likely triggers data exchange in near future.

As a result, the UE device requests deregistration at the second PLMN. The request may include an information that the deregistration takes place in order to reregister over another path, i.e. RAN 2, or that the registration is requested to only be suspended until a reregistration takes place.

Once the UE device receives a confirmation from the second PLMN about a successful deregistration or suspension of the connection via N3IWF, the UE device requests a release of the user plane resources, i.e. PDU session(s) used for connecting to the N3IWF of the second PLMN, followed by a release of the signaling connection. The release of the signaling connection may be requested actively by the UE device via NAS signaling or the UE requests a release of the RRC connection at RAN 1. The release of the signaling connection may alternatively be triggered by the first PLMN based on the release of the last user plane resources of the UE device and the resulting lack of activity.

The UE device is now back to idle mode in the first PLMN. It is reachable by the first PLMN via paging and it can access RAN 1 if necessary, e.g. due to another paging or due to a mobile originated call or data transfer.

In order to be reachable also by the second PLMN, the UE device will perform a cell search and selection and initiate a registration of a radio path at the second PLMN via RAN 2. For this registration to take place, an RRC connection between the UE device and RAN 2 is set up which leaves the UE device unreachable in the first PLMN.

Now, a determination will take place similar to the determination during the connection to the first PLMN whether the UE device needs to be reachable in the second PLMN. This time, the determination results in that for the short period, the UE device needs to register the path via RAN 2 in the second PLMN, a registration via a PDU session in the second PLMN and N3IWF of the first PLMN is not necessary.

It is thus an aspect of this invention to determine whether an alternative path via the user plane of the first (or the second) PLMN to reach an interworking function of the second (or the first) PLMN is necessary. This determination can be based on any of
the time envisaged to stay connected in the first PLMN,
whether user data is to be transmitted in the first PLMN and if so, the amount of user data to be transmitted,
what kind of service is requested from or set up with the first PLMN, and
the current mobility status of the UE device, e.g. based on past movement or cell changes of the UE device, an estimation of the likelihood of the UE device coming back to a cell of the second PLMN in which it is already or still registered.

In a second embodiment, which is described in the following, the first PLMN triggers the release of the alternative path. This embodiment is very similar to the first embodiment and will therefore be explained on the basis of FIG. 4 only describing the difference to FIG. 3 and the first embodiment.

The prerequisite for the second embodiment is similar to the first: After the UE device has established an active link to the first PLMN and it has determined the necessity to connect to the second PLMN via a link through the first PLMN it requests to set up user plane resources, i.e. one or more PDU sessions, to connect to the N3IWF of the second PLMN.

Now, according to the second embodiment, this request includes information (“[Info]” in FIG. 4) that informs the first PLMN that the PDU session or sessions is required only as long as for other purposes the UE has to stay in connected mode in the first PLMN. It may be that the information simply flags the PDU session or sessions as being established for registration in another PLMN. This enables the first PLMN to derive that the necessity to maintain this or these PDU sessions is bound to other reasons for a connection to the first PLMN.

Alternatively, the information explicitly describes that relation, potentially without indicating the purpose of the PDU session(s) being for connecting to another PLMN. This information newly provided to the first PLMN enables the first PLMN to determine the time for releasing PDU sessions autonomously without receiving a trigger from the UE device.

After the user plane resources for connecting the second PLMN have been established in the first PLMN, the UE device registers the alternative path in the second PLMN. According to the current example, the mobile terminated call in the first PLMN ends and the respective user plane resources are released.

It is now the first PLMN that determines, that the PDU sessions currently established are obsolete if the UE device is released to idle mode after a release of the used resources. The determination is based on the established PDU sessions that are now only for the purpose of connecting to the second PLMN, and on the absence of a further need to exchange any data with the UE device for services provided by the first PLMN. The first PLMN releases the resources, in FIG. 4 this is indicated by sending a PDU session release command to the UE device.

According to the current invention, the UE device deregisters from the second PLMN before terminating the resources. As in the first embodiment, the deregistration request may include an information that the deregistration takes place in order to reregister over another path, i.e. RAN 2, or that the registration is requested to only be suspended until a reregistration takes place.

After the deregistration is confirmed by the second PLMN, the UE device and the first PLMN release the left-over user plane resources and RAN 1 releases the UE device to idle mode. Subsequently, the UE device will register a new path via RAN 2 in the second PLMN as in the first embodiment.

In a third embodiment, the decision to release the alternative path is taken by the UE device while USIM 2 is connected. The embodiment is now described based on FIG. 3 including the dashed lined objects and described in detail only where the embodiment deviates from the first embodiment.

After the UE devices has set up a connection to the first PLMN for establishing the mobile terminated voice call, and it has set up PDU sessions for connecting to the N3IWF of the second PLMN and registered the alternative path in that PLMN, data is assumed to arrive for the UE device in the second PLMN, i.e. from a service provider in the internet. Downlink data arriving and pending delivery in the network triggers paging of a UE device in idle mode. In this case, as the UE device is registered over the alternative path, the paging is carried in a notification message sent over the alternative path requesting the UE device to trigger user plane establishment with the setup cause being DL data pending. When the user plane resources in the second PLMN, i.e. one or more PDU sessions, have been set up over the alternative path via the first PLMN and the N3IWF, the DL data can be delivered, and potentially generated UL data can in response be transferred to the service provider. The UE device is then in connected mode also in the second PLMN.

When now the voice call in the first PLMN ends and the user plane resources are released, the UE device has to determine whether releasing the alternative path and the connection to the first PLMN to set up a direct path to the second PLMN via RAN 2 is beneficial over the established connection via the first PLMN and the N3IWF.

This determination is much more complex for the UE device being in connected mode in the second PLMN than for the idle mode case. Due to the limited transmission and potentially reception capabilities of the UE device, a switch from the alternative path to the direct path will result in an interruption of the established data transfer. It is thus a further aspect of this invention to base the determination whether to request a release of the alternative path and the connection to the first PLNM and establish a direct path to the second PLMN on at least one of the following four parameters.

(i) The vulnerability of the service or services provided over the alternative path from service interruptions, from a temporary decrease in data rate and/or increase in latency, response time or round-trip-time and from a change of the IP-address.

(ii) The availability of an interworking function in the first PLMN that allows access to the first PLMN over the second PLMN and the interworking function, i.e. the possibility to invert the direct and alternative path usage for the first and second PLMN, respectively.

(iii) The costs of data transfer via the alternative path compared to a data transfer via the direct path.

(iv) The available quality of service in RAN 1, the first PLMN and/or the path between first PLMN and N3IWF of the second PLMN in comparison with an estimated quality of service in RAN 2.

The determination is done taking any of these parameters into account and using either a UE device implemented and proprietary algorithm, and/or it takes rules and policies received from the first PLMN, the second PLMN or both PLMNs into account which are received during registration or configuration in the respective PLMN.

For example, the UE device may decide that an alternative path currently used for a voice service in the second PLMN is beneficially continued over the alternative path as users of a conversational voice service experience very bad service in case of interruptions. Another UE device may decide that a video streaming service benefits from the switch from the alternative to a direct path in case the estimated data rate in RAN 2 is significantly higher than that of RAN 1. Even if the data rate does not bear any benefit, the costs of a direct connection may be lower due to the subscribed service in PLMN 2 than those of the alternative path and the UE device may initiate the switch of paths.

The second PLMN may during or after registration configure the UE device with a rule that only allows not to switch from the alternative to a direct path, if a voice call is ongoing with the second PLMN, in all other cases the UE device must initiate the switch. These examples should just provide sufficient detail to understand that various combinations of parameters and rules will lead to a determination of whether a switch needs to be initiated by the UE device or not.

If the determination leads to a switch to be executed, the UE device will as in the first embodiment request a deregistration at the second PLMN. The UE device may first request the release of user plane resources followed by the deregistration or it may request both in a single step. The second PLMN will release the user plane resources and accept the deregistration. The request to deregister or to release resources may include a notice that a reregistration will be performed shortly and therefore the registration and potentially also the user plane resources, i.e. PDU sessions, may be suspended instead of being released until the UE requests to register a direct path via RAN 2. The second PLMN may include in the deregistration acceptance message information that helps in reregistering the UE device over RAN 2, e.g. a new AMF address.

As in the first embodiment, the UE device's user plane resources are requested to be released by the UE device which leads to a release of the UE device into idle mode in RAN 1 and the transceiver resources of the device are free to re-register a direct path to the second PLMN.

In a fourth embodiment the decision to release the alternative path is taken by the first PLMN based on information received from the UE device after USIM 2 was connected. The embodiment is now described based on FIG. 5 only in enough details to understand the difference to the second and third embodiment.

After the UE device has set up a connection to the first PLMN for establishing the mobile terminated voice call, it requests the setup of one or more PDU sessions for connecting to the N3IWF of the second PLMN. As in the second embodiment, this request includes information that informs the first PLMN that the PDU session or sessions is required only for the purpose of connecting to the second PLMN while the first PLMN offers a service to the UE device. This information provided to the first PLMN enables the first PLMN to triggering release of the connection to the UE device autonomously as in the second embodiment.

The UE device then registers the alternative path in the second PLMN. Some time after that, data is assumed to be generated by an application of the application layer of the UE device. The data is to be sent in uplink to the second PLMN, e.g. to a service provider in the internet. The UE device transmits a service request message to the second PLMN including information about the type and quality of service and the destination data network of the data. The second PLMN will respond with the setup of user plane resources, i.e. the requested PDU sessions, over the alternative path. Data can now be transmitted in UL and potentially resulting DL data can be received by the UE device via the second PLMN and the alternative path. The UE device is then in connected mode in the second PLMN.

According to the fourth embodiment, the UE device now provides information to the first PLMN, e.g. in a PDU session modification request, about the change of use of the one or more PDU sessions of the alternative path. The information provides to the first PLMN the information that autonomous release of the PDU session(s) that is/are used for the alternative path is not appropriate or that the UE device is now in connected mode in another PLMN and release of resources autonomously by the first PLMN may significantly interrupt service with another PLMN.

At a time after that, the voice call of the UE device in the first PLMN ends and the user plane resources, i.e. the related PDU sessions are released. According to the current embodiment the first PLMN does not determine a release of PDU sessions of the alternative path as it is informed about PDU session being used to maintain PDU sessions between the UE device and the second PLMN.

It is assumed in this example that some time after that the data exchange between the UE device and the service provider has ended and the user plane resources in the second PLMN transported over the alternative path are released.

According to this embodiment, the UE device informs the first PLMN newly about a change in usage of the PDU sessions of the alternative path, e.g. in a new PDU session modification request message informing about the renewed applicability of the autonomous release of the PDU sessions of the alternative path by the first PLMN. Alternatively, the first PLMN is informed that the UE device is now in idle mode in the other PLMN and would therefore benefit from being released to idle mode.

Consequently, the first PLMN may take the decision to release the UE device to Idle Mode as in the second embodiment.

In a fifth embodiment the decision to release the alternative path is taken by the first PLMN after USIM 2 is connected.

After the UE devices has set up a connection to the first PLMN for establishing the mobile terminated voice call, it requests the setup of one or more PDU sessions for connecting to the N3IWF of the second PLMN. The UE device registers the alternative path in the second PLMN.

A while after that, data is assumed to be generated by an application of the application layer of the UE device. The data is to be sent in uplink to the second PLMN, e.g. to a service provider in the internet. The UE device transmits a service request message to the second PLMN including information about the type and quality of service and the destination data network of the data. The second PLMN will respond with the setup of user plane resources, i.e. the requested PDU sessions, over the alternative path.

According to the fifth embodiment, an implementation option of the 3GPP system similar to the one described in 3GPP TS 23.501 at 5.30.2.7 and 5.30.2.8, will be used. For every PDU session or for every PDU session with different QoS a separate IPsec-child-security-association between the UE device and the IWF of the second PLMN will be established. According to this invention, in addition in the first PLMN a separate PDU session for every IPsec-child-security-association is set up between the UE device and the UPF of the first PLMN. These PDU sessions are set up with a QoS according to the respective PDU sessions that is tunneled through the PDU sessions and the respective IPsec-child-security association.

As a result, the first PLMN can determine the state of connection between the UE device and the second PLMN. The determination can be based on the number and/or QoS for PDU session set up for communication between the UE device and the IWF of the second PLMN. The first PLMN may for example associate the first of such PDU sessions with the NAS signaling connection from the UE device to the AMF of the second PLMN because the establishment of this interface is the base for further setup of data connection. The first PLMN may associate all further of such PDU sessions to PDU sessions set up in the second PLMN for data exchange. The determination may alternatively or in addition take the QoS requested for the respective PDU sessions in the first PLMN into account. The first PLMN may for example associate a PDU session with typical NAS signaling QoS, i.e. low data rate, mid latency and high reliability, with the NAS signaling connection while PDU sessions with typical QoS for data exchange are associated with PDU sessions in the second PLMN.

In addition or alternatively, the UE device may provide with each PDU session requested in the first PLMN for IPsec-security-associations or IPsec-child-security-associations an indication whether the PDU session is used for a NAS signaling connection or for a PDU session in the second PLMN for data transfer.

The first PLMN is now enabled to autonomously detect the state of the connection of the UE device in the second PLMN. If the UE device does not have PDU sessions established that are associated with PDU sessions in the second PLMN, except the PDU session for the NAS signaling, the first PLMN can autonomously decide to request a deregistration of the UE device as described in the former embodiments.

In other words, as the first PLMN is enabled to distinguish NAS signaling connections from PDU sessions in both the first and second PLMN, the first PLMN can now simply base the deregistration trigger for the UE device on the absence of PDU sessions for data transfer. A deregistration request sent by the first PLMN to the UE device allows the UE device to deregister in the second PLMN before acknowledging the request and moving to idle mode.

As mentioned in previous embodiments, some PDU sessions established in the second PLMN may be of lower priority or may not suffer from short gaps in data transmission. These PDU sessions can be identified by the first PLMN by their QoS parameters requested by the UE device or a respective indication may be explicitly provided by the UE devices when requesting the setup of the PDU session. The first PLMN is thus enabled to determine the deregistration of the UE device based on the absence of PDU sessions with higher priority or PDU sessions suffering from transmission gaps in the second PLMN.

1. A method for controlling a connection of a user equipment, UE, device having more than one subscriber identity module, SIM, to at least a first and a second public land mobile network, PLMN, in which initially the UE device is connected to the first PLMN via a radio access network, RAN, of the first PLMN forming a first connection associated with a first SIM and the UE device is connected to the second PLMN via a data network of the first PLMN and an interworking function of the second PLMN forming a second connection associated with a second SIM, the method comprising:
determining that the first connection is being maintained only for maintenance of the second connection; and then
causing the second connection to be released and a new connection associated with the second SIM to be established with the second PLMN via an access network of the second PLMN.

2. The method according to claim 1, wherein initially the first connection is set up for the UE device to receive one or more first services from the first PLMN other than setup of the second connection; and
the determining that the first connection is being maintained only for maintenance of the second connection comprises determining that the one or more first services are released or can be released.

3. The method according to claim 1, wherein the method further comprises
determining whether the second connection is in an active state in which user data is being transmitted or in a passive state in which no user data is being transmitted; and
causing the second connection to be released and the new connection associated with the second SIM to be established with the second PLMN only if the second connection is in a passive state; or
if the second connection is in an active state and it is determined that the second connection should not be continued via the data network of the first PLMN and the interworking function of the second PLMN; and
continuing the second connection via the data network of the first PLMN and the interworking function of the second PLMN otherwise.

4. The method according to claim 1, wherein the first PLMN determines that the first connection is being maintained only for maintenance of the second connection.

5. The method according to claim 4, wherein a request sent by the UE device to the first PLMN to establish the second connection via a data network of the first PLMN contains information informing the first PLMN that the connection to the data network of the first PLMN is required only as long as the UE device receives the one or more first services from the first PLMN.

6. The method according to claim 5, wherein the first PLMN determines that the second connection is in a passive state by determining that no packet data unit, PDU, sessions are established with the UE device for the second connection within the second PLMN and sends a PDU session release command to the UE device.

7. The method according to claim 6, wherein the UE device deregisters from the second PLMN before releasing PDU session resources in the first PLMN.

8. The method according to claim 5, wherein the UE device provides information to the first PLMN informing the first PLMN that the second connection should not be released until further information is provided.

9. The method according to claim 5, wherein the first PLMN determines a status of the second connection by monitoring whether a packet data unit, PDU, session established in the second PLMN is being used for data transfer other than for signaling data transfer.

10. The method according to claim 1, wherein the UE device determines that the first connection is being maintained only for maintenance of the second connection.

11. The method according to claim 10, wherein the UE device determines that the second connection is in a passive state, requests a deregistration from the second PLMN and following a successful deregistration requests a release of packet data unit, PDU, sessions used for connecting to the interworking function of the second PLMN.

12. The method according to claim 10, wherein the UE device determines that the second connection is in an active state and determines whether the second connection should be released taking into consideration at least one parameter from a list comprising:
a vulnerability of a service provided over the second connection to a decrease in data rate, an increase in latency, an increase in response time, an increase in round-trip time or a change of an internet protocol address;
an availability of an interworking function in the first PLMN for a connection with the UE device via the second PLMN;
a cost of data transfer over the second connection compared with a cost of data transfer with the second PLMN directly; and
an available quality of service, QoS, over the RAN, a QoS in the first PLMN, a QoS between the first PLMN and the interworking function of the second PLMN and an estimated QoS for a direct connection to the second PLMN.

13. The method according to claim 1, wherein the step of determining that the first connection is being maintained only for maintenance of the second connection comprises determining that no user date are being transmitted using the first connection or the second connection.
